(19) United States
(12) Patent Application Publication
(10) Pub. No.: US 2020/0021101 A1
(43) Pub. Date: Jan. 16, 2020

(54) Fire Protection Device for Photovoltaic Modules

(71) Applicant: IMO PRECISION CONTROLS LTD, London (GB)

(72) Inventors: Cristiano Giacolini, London (GB); Graham Viney, London (GB)

(21) Appl. No.: 16/495,326

(22) PCT Filed: Mar. 23, 2017
(86) PCT No.: PCT/IB2017/051686

§ 371 Date: Sep. 18, 2019

(51) Int. Cl. H02H 5/04; H02J 3/38; H02M 3/335

(52) U.S. Cl. CPC H02H 5/04; H02M 3/33523; H02J 3/383

(57) ABSTRACT

A protection device, included in a protection system for photovoltaic generators, connected in series to form at least a string of generators connected to at least one inverter, of the type that can be installed between each generator and the inverter to form a string comprising a plurality of protection devices connected in series, comprises a photovoltaic side protection stage and a device side control and protection stage, galvanically isolated from each other, capable of controlling the state of a photovoltaic side switch and of controlling the interruption of power supply of the device which follow along the string. The protection system, cheap and useful to be installed, is capable of protecting the photovoltaic generators from fires, localized overheating, malfunctions and voltage overloads, of constantly monitoring the operating temperature and the supply voltage of the apparatus to which it integrates and is also capable of autonomously unpowering itself on condition and automatically unpowering the apparatus to which it integrates on condition, due to the fact that it is not affected by the electric state of the generators, being from them galvanically isolated.

### TECHNICAL FIELD

The present invention fits in the sector of safety and protection devices for photovoltaic installations and in particular of techniques and devices for the control, evaluation and activation of protection override in case of malfunction, overloading or overheating of said installations.

### BACKGROUND ART

Photovoltaic installations typically include a certain number of photovoltaic panels connected in series to form a string. A string is connected to a string inverter, which can be a “grid-tie” inverter type, which means that directly connects the photovoltaic installation to the AC public grid. The photovoltaic panels are composed of photovoltaic modules, namely non-linear current generators, with functioning curves described by the manufacturers. Inverters, however, are devices capable of extracting the maximum power available in direct current (DC) from the photovoltaic modules, tracking a maximum power point (MPPT), and feeding power into the grid to which they are connected in the form of alternating current (AC). Since the photovoltaic modules are power generators connected in series, in order to reach the inverter working voltage, if, as happens in reality, the modules are not all identical, the string current will be the one of the generator that provides the smaller value. This implies that, without proper precautions, no module, and in the best case only one, works at its maximum power point.

A very frequent event in photovoltaic installations is partial or total shading of some cells or even of whole strings. This eventuality is harmful and it is obviously proper to reduce it as much as possible already during the design and installation stage. However, the location of the panels does not always guarantee that shaded areas are not present along the year and, above all, it is not possible to predict or prevent cases of accidental shading caused by the fall of the trees leaves or by the natural amount of dirt.

In such cases, the operation of the system is affected because the production of the panel containing the cells or modules subject to such shading decreases and may cause side effects such as the triggering of hot spots that would damage the cells themselves. In the event of shading, in fact, the conventional cell, being in series, does not let current pass as it should and is reverse biased with a voltage equal or very close to the no-load voltage of the entire series formed by the remaining cells with the risk of entering in reverse conduction.

In this case the cell would have to dissipate the power generated by the remaining cells of the module with the consequent local temperature raise (hot spot precisely) that may give rise, even with modest solar radiation values, to the destruction of the cell due to over-temperature. In the even worse event of a hot spot being adjacent to an accumulation of foliage, the latter can become overheated which could eventually trigger a fire which would be fuelled by the highly flammable foliage.

To overcome as much as possible this drawback, protection techniques of the modules cells have been developed with the goal of avoiding the overheating drawback even to the detriment of the production of the panels themselves.

The current state of the art provides that, in the junction box, are present some “bypass” diodes capable of allowing the current to keep flowing in a string of panels placed in series bypassing a shaded cell or module, ensuring this way the continuation of the power harvesting. Basically, these are diodes that are inserted in photovoltaic panels or in strings in order to avoid that in the cells or in the strings a possible reverse current can circulate thus creating hot spots which could damage the cells themselves. Each bypass diode within a module protects a certain number of cells, so as to allow the partial exclusion of the shaded part of the module and avoiding that the consequent reduction of current affect the entire string, with the inevitable loss of energy harvested. In fact, a shaded cell is like a battery that supplies a current lower than another having the same voltage but a higher capacity.

Present protection systems, however, show off some more weaknesses in terms of safety, related to the fact that the photovoltaic generators are powered directly by the sun, and then, in the event of problems located directly on the installation, and in particular in the event of problems on the generators cells themselves, they can not he totally unpowered. A photovoltaic panel produces electricity as long as it is hit by sunlight and therefore it is not possible to put the system out of tension otherwise than turning the sun off. So, as long as there is sunlight, the installation keeps producing electric power. In fact, if a fire or an overheating occurs at the installation, due to external or internal causes, the human intervention can not be made in safe conditions since the electric lines of the photovoltaic strings are still powered with tensions not biologically safe, not to mention the fact that the tensions themselves feed the fire.

### SUMMARY OF INVENTION

It is an object of the present invention to propose a system for the preservation and protection of photovoltaic installations from fires and localized overheating.

It is another object of the present invention to propose a system for the preservation and protection of photovoltaic installations from malfunctions and voltage overloads.

It is another object of the present invention to propose a protection system which can be integrated into photovoltaic installations of any type, power and working voltage.

A further object of the present invention is to propose a protection system that can constantly monitor the operating temperature of the apparatus to which it is integrated.

Another object of the present invention is to propose a protection system that can constantly monitor its supply voltage and of the apparatus to which it is integrated.

A further object of the present invention is to propose a protection system that can be galvanically isolated from the photovoltaic installation to which it is integrated.

According to a first aspect of the invention, the above objects are achieved by means of a protection device for photovoltaic generators associated in series to form at least one string of generators connected to at least one inverter, with said device of the type installable interposed between each generator and said inverter to form a string comprising a plurality of said devices connected in series, the device being characterized in that said protection device comprises:

a photovoltaic side protection stage, comprising:
photovoltaic side input means, for the electrical connection of photovoltaic panels,
inverter side output means, for the outlet connection to said inverter,
a photovoltaic side protection circuit interposed between said photovoltaic side input means and said inverter side output means,

a device side control and protection stage, comprising,
supply voltage measuring means, for measuring the supply voltage in said device side control and protection stage,
temperature measuring means,
at least one controller suitable to process information received by said supply voltage measuring means and from said temperature measuring means and consequently control said photovoltaic side protection circuit, wherein said photovoltaic side protection stage being galvanically isolated from said device side control and protection stage.

Advantageously, the photovoltaic side protection circuit comprises a photovoltaic side switch interposed between said photovoltaic side input means and said inverter side output means, said photovoltaic side switch being realized by means of a field-effect transistor.

Advantageously, said photovoltaic side protection circuit comprises a protection device against reverse polarity.

Advantageously, said photovoltaic side protection circuit comprises protection components, driving components and galvanic isolation components suitable to allow the monitoring of said driving components by said controller maintaining said device side control and protection stage and said photovoltaic side protection stage galvanically isolated from each other.

Advantageously, the device side control and protection stage comprises an electric supply circuit for supplying said controller and said photovoltaic side protection stage, said electric supply circuit comprising power supply input means for the connection of a power source of said device, the power supply output means for connection of a following device of said string to be supplied, power output interruption components for interrupting the power supply between said power supply input means and power supply output means.

Advantageously, said power output interruption means comprises at least one switch controlled by said controller.

Advantageously, said electric supply circuit includes protection components interposed between said power input means and said controller adapted to protect said device against polarity reversals and to limit the current of the power transients, making at the same time not to cause the intervention of protections present in an external power circuit.

According to another aspect of the invention, the above said objects are achieved by a protection system for photovoltaic installations comprising a plurality of photovoltaic generators with direct current, wherein each generator is connected to a protection device and said protection devices are connected in series to form a string connected to at least an inverter, each of said devices being provided with protection members to interrupt the storage of energy by the photovoltaic generator associated through at least one switch, said system being characterized in that the string of protection devices is power supplied by an electricity grid by means of a power supply circuit, each of said devices being able to interrupt the power supply to the devices following it along said string.

Advantageously, each device of said string processes data detected by temperature measuring means and by supply voltage measurement means and consequently controls the state of its photovoltaic side switch.

Advantageously, each device of said string processes data detected by the temperature measuring means and by supply voltage measurement means and consequently controls the power supply to devices following it along said string.

### BRIEF DESCRIPTION OF DRAWINGS

These and further advantages of the invention will be better understood by an expert in the field from the following description and from the accompanying drawings given as non-limiting embodiment, in which:

FIG. 1 Shows a block diagram of a photovoltaic installation provided with a monitoring and protection system according to the present invention and comprising a plurality of protection devices according to the invention;

FIG. 2 Shows a block diagram of the components of a protection device included in the installation of FIG. 1;

FIG. 3 Shows a flow diagram of the operating mode of the protection device of FIG. 2;

FIG. 4 Shows a schematic representation suitable to show the arrangement of the current interruption means of the device of FIG. 2;

FIG. 5 Shows a circuit diagram of a portion of the device of FIG. 2.

### DESCRIPTION OF EMBODIMENTS

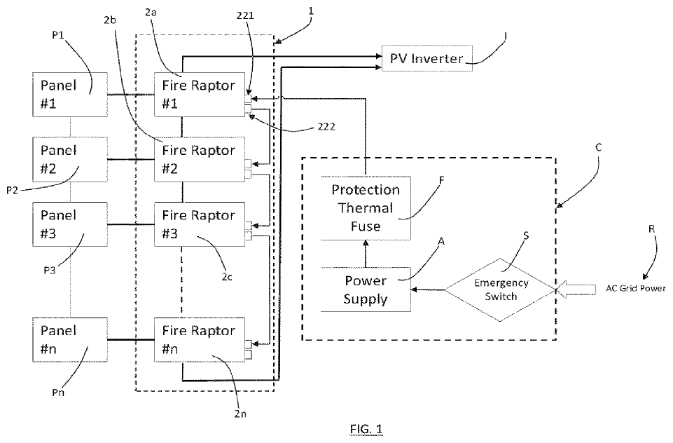

Referring to FIG. 1, it is schematically illustrated a photovoltaic installation comprising protection devices, from 2a to 2n, according to the present invention. The photovoltaic installation includes photovoltaic panels, from P1 to Pn, an inverter I, and a number of the above said protection devices from 2a to 2n equal to the number of the panels. Each panel P is connected to a respective protective device 2, while the devices from 2a to 2n are arranged in series to form a string of devices, 1, connected to said inverter I.

For ease of reference, with the following description a protection device will be generically indicated with 2, while when it will be necessary to refer to a given device of the string 1, it will be shown the relative suffix. The same will be for the photovoltaic panels P.

In alternative embodiments of the invention each protection device 2 can be attached to two panels P, and each panel is a attached to a single protection device 2 so that the amount of panels P in a string is a multiple of the amount of the protection devices 2 thereof. Such an embodiments leads to a reduction of the total cost of the photovoltaic installation because of the reduced amount of protection devices installed.

Returning to the embodiment of FIG. 1, a first protection device, 2a, is directly connected to the inverter I as the first in the series and is at the same time connected to a following second device, 2b, of the series of devices 2. The first protection device 2a is also connected to a first panel, P1, this way interposing between that and the inverter I. The protection device 2a is connected to the grid, R, through a power supply circuit, C, comprising at least one thermal fuse, F, feeding members, A, and a general manual switch, S. Said first protection device 2a is suitable to supply power to a second protection device, 2b, of the series, connected to a second panel, P2, and so on. With the same methods of the previous, each of the panels P included in the photovoltaic installation is connected to a relative device 2, while the latter are connected in series to form a string 1 connected to the inverter I. A final protective device 2n of the string is therefore connected to a respective photovoltaic panel. Pn, and is connected on the output to the inverter I.

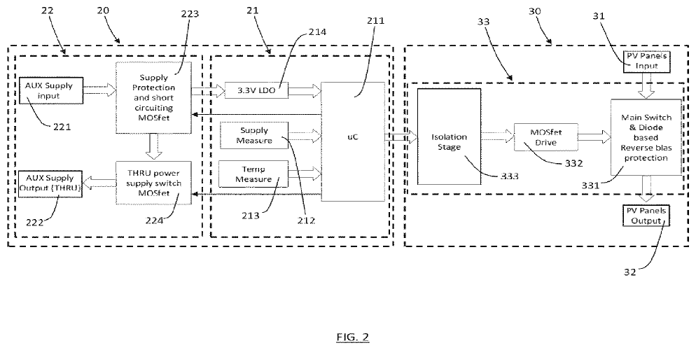

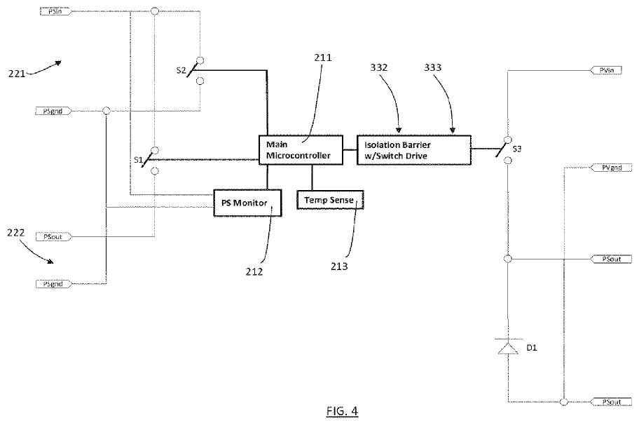

With reference to FIGS. 2 and 4, it is shown a protection device 2 with evidence, in the case of FIG. 2, of the main functional blocks that compose it and, in the case of FIG. 4, of the positioning of the power failure means present in the device itself. A device side control and protection stage, 20, comprises an electric power supply circuit, 22, and a control electric circuit, 21. The electric power supply circuit 22 comprises power input means, 221, adapted to the connection of electrical power supply means of said device 2, and power output means, 222, adapted to connect additional devices 2 that said device side control and protection stage 20 must electrically supply. In particular, with reference to the system diagram shown in FIG. 1, in a first device 2a of the string, the power input means 221 are connected to the grid R by means of the power circuit C, while in the following devices from 2b to 2n the power input means 221 are connected to the power output means 222 of a respective device 2 that precedes it in the string 1; similarly the power output means 222 are connected to the power input means 221 of a respective device 2 that follows it in the string 1, except of the power output means 222 of the last device 2n that are not connected to other devices. The electric power supply circuit 22 also includes protection and interruption components, 223, and power output interruption means, 224. The control electric circuit 21 comprises a controller, 211, responsible of the control of the entire protection device 2, voltage regulators, 214, temperature measurement means, 212, and supply voltage measurement means, 213, suitable to detect the supply voltage in the power supply circuit 22. The aforementioned voltage regulators 214, temperature measurement means 212 and supply voltage measurement means 213 handle the power supply of the controller 211 and provide devices suitable to convert and scale the voltages and currents present in the system in a range such that it is possible the reading by means of analog/digital converters, typically integrated in the logic of the controller 211 and comprising all the conditioning/filtering of the parameters so that they are confined within the predefined ranges from the generators P, making the protective device 2 immune to external disturbances, both of the conducted and disbarred type.

The device side control and protection stage 20 interfaces with a photovoltaic side protection stage, 30, which comprises photovoltaic side input means, 31, for the electrical connection of a photovoltaic panel P, inverter side output means, 32, for the outlet connection to a next device in said string 1 and a photovoltaic side protection circuit, 33, interposed between the photovoltaic side input means 31 and the inverter side output means 32. The photovoltaic side protection circuit 33 comprises protection components, 331, drive members, 332, and galvanic isolation components, 333, suitable to allow the monitoring of the drive members 332 by the controller 211 maintaining the device side control and protection stage 20 and the photovoltaic side protection stage 30 galvanically isolated from each other. Such isolation is sufficient to ensure the proper functioning of the ground insulation resistance measurement systems inside the photovoltaic inverter I. As shown in FIG. 4 the protection components 331 comprise a switch, S3, and a protection device against reverse polarity, D1. The photovoltaic side protection circuit 33 is power supplied by the device side control and protection stage 20 and is able to maintain the switch S3 active regardless of the behavior of the photovoltaic generator P associated and of the functioning of the inverter I. Advantageously, the galvanic isolation components 333 are constituted by a transformer having the required isolation level, to which is associated a control circuit connected to the controller 211. More in detail, the galvanic isolation components 333 and drive members 332 of the protection circuit 33 include an oscillator, a transformer and a conversion system from the pulsed mode to the continuous mode. The drive members 332 are controlled by means of a digital line from the controller 211 able to oscillate at a frequency compatible with the isolation transformer used. The driving topology is advantageously of the half-bridge type using an appropriate connection circuit. The use of the said driving topology allows the use of an isolation transformer which does not store energy during the not active working cycle (flyback). The output of said transformer is connected to a multiplication network made of diodes and condensers to obtain the voltage required to activate the switch S3, which is advantageously constituted by a field-effect transistor (FET) of which are controlled the closing time (turn-on) and opening time (turn-off) by means of suitable drive members 332 advantageously comprising a bipolar PNP transistor, a diode and a passive components network capable of controlling the opening time. The use of passive components is necessary since the device starting is performed in the output current regime close to zero (system disconnected).

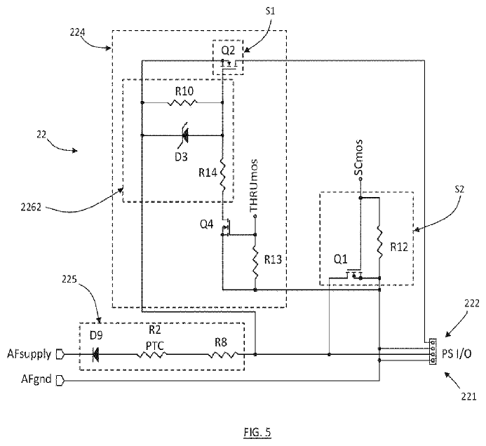

With reference to FIG. 5, is now described in more detail the electric power supply circuit 22 of the device side control and protection stage 20.

The electric power supply circuit 22 comprises an input/output power connector which constitutes the power input means 221 and the power output means 222.

The circuit 22 through the AFsupply and AFgnd lines brings the power to the controller 211 and to the device side protection stage 30.

Along the AFsupply line are arranged protection members, 225, of the protection and interruption components 223, constituted by a diode D9, a temperature-dependent resistive component, R2, and by a further resistive component, R8, which protect the device against the polarity reverse and limit the current of the supply transients, doing at the same time so as to not cause the intervention of external protections, such as the thermal fuse F, and of any other protective devices against extra currents present in the supply circuit C.

A switch, S2, of the protection and interruption components 223 is formed by a field-effect transistor, Q1, and by a resistor, R12, and is driven by the controller 211 via the SCmos drive line. When the switch S2 is closed the power input means 221 are circuited and then it is enabled the thermal fuse F or other protection means placed upstream of the power input means 221.

The power output interruption means 224, schematically represented in FIG. 4 by the switch S1, have the function of enabling or not the power supply to the following devices 2 in the string 1 and then they are interposed between the power input means 221 and the power output organs 222. A related switch. S1, is realized by means of a field-effect transistor (FET), Q2, and is controlled by the controller 211 through the control line indicated with THRUmos and the R13 and Q4 components. A sideshift circuit, 2262, composed by the components R10, D3 and R14 is a level sideshift necessary to the switch S1 driving by means of the controller 211 with power supply referred to AFgnd.

Downstream of the protection members 225, along the supply line AFsupply. AFgnd, the power supply of the controller 211 is performed by means of the voltage regulators 214.

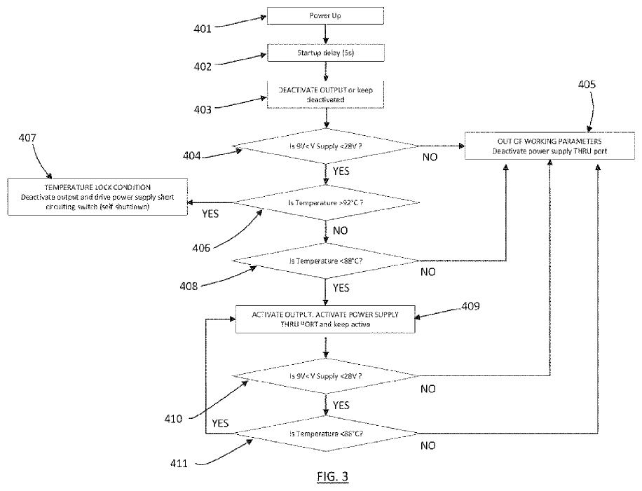

With reference to FIG. 3 is now described an example of the functioning of a device 2 according to the invention, controlled by the controller 211, which may for example be a microcontroller with CPU, I/0 and analog/digital converter integrated or a programmable logic device or hybrid like a CPLD (complex programmable logic device) or an FPGA (field programmable gate array).

Generally, the controller 211 processes the data detected by the temperature measuring means 213 and by the supply voltage measurement means 212 and consequently controls the photovoltaic side switch S3 state and the device side switches S1 and S2.

More specifically, an example of the device 2 management mode by the controller 211 is the following. Following the power supply of the device, 401, the starting of the same is timed, 402, to start with a delay of a few seconds, after which the photovoltaic side switch is preliminarily opened, 403.

It is then carried out the detection of the supply voltage of the device, 404, through the supply voltage measurement means 212: if this detection provides a value not contained within a predetermined established safety range, the controller 211 controls the opening of the switch S1, 405, thus preventing the power supply of the device 2 which follows along the string 1 and also keeps the photovoltaic side switch S3 open; differently, if the detection provides a value within said predetermined safety range, it proceeds to the next detection.

The next control is a temperature detection by the temperature measurement means 213, to check if this is below a first safety value, 406: if this detection provides a value higher than said first safety value the controller 211 controls the closure of the S2 switch, 407, by shorting the power input means 221, and then causing the enabling of the thermal fuse F or of other protection members located upstream of the device in the supply circuit C. If instead the detected temperature value is below the said first safety value, it is then verified if it is also below a second safety value, 408, lower than the first: if the detected temperature is higher than the second safety value the controller 211 controls the opening of the switch S1, 405, thereby preventing the power supply of the device 2 following it along the string 1 and also keeps the photovoltaic side switch S3 open; if instead the detected temperature is lower than the abovementioned second safety value then all the parameters appear to he in accordance with the normal operation mode of the device 2 and the photovoltaic side switch S3 and the device side switch S1 are being closed, 409, thus enabling, respectively, the production of energy from the panel associated and the power supplying of the following device 2.

Once the device is in normal operating conditions 409, it continues the monitoring of the supply voltage, 410, and the monitoring of the temperature, 411. Should the temperature and/or voltage be out of the predetermined intervals for the normal operation, the controller 211 controls the opening of the switch S1 with the consequence of power interruption to the following device, 405, and the opening of the photovoltaic side switch S3, with consequent interruption of the current storage from the associated panel P, 403, and then to resume the already outlined controls until the re-establishment of the normal operating conditions of the device.

The specific operation mode described above must be understood as purely exemplary and not limiting of a control mode of an invention device based on the voltage and temperature measurements provided by measurement components internal to the device itself.

Similarly, the provided detailed description of specific components and circuit topologies must be understood only as illustrative and not restrictive. For instance, in different embodiments of a device 2 according to the invention one or both the switches S1 and S2 are not provided and the circuit topology accordingly is changed. For instance, in an embodiment in which switch S1 is not provided the power supplied to a device following in the string is not controlled so that there is no power supply control along the string 1.

In any case, the field experts will be able to implement the invention with even very different circuit diagrams, without departing from the inventive concept defined in the claims that follow.

1.-20. (canceled)

21. A protection device for photovoltaic generators in direct current associated in series to form at least one string of generators connected to at least one inverter, with the device installed and interposed between each generator and the inverter to form a string comprising a plurality of the devices connected in series, comprising:
a) a photovoltaic side protection stage, comprising:
photovoltaic side input means, for electrical connection of photovoltaic panels;
inverter side output means, for outlet connection to the inverter; and
a photovoltaic side protection circuit interposed between the photovoltaic side input means and the inverter side output means; and
b) a device side control and protection stage, comprising:
voltage measurement rears, for measuring supply voltage in the device side control and protection stage;
temperature measuring means; and
at least one controller suitable to process information received by the voltage measurement means and from the temperature measuring means and consequently control the photovoltaic side protection circuit;
wherein the photovoltaic side protection stage is galvanically isolated from the device side control and protection stage.

22. The protection device according to claim 21, wherein the photovoltaic side protection circuit comprises a photovoltaic side switch interposed between the photovoltaic side input means and the inverter side output means, the photovoltaic side switch being realized by means of a field-effect transistor.

23. The protection device according to claim 21, wherein the photovoltaic side protection circuit comprises a protection device against reverse polarity.

24. The protection device according to claim 21, wherein the photovoltaic side protection circuit comprises protection components, drive members and galvanic isolation components operable to allow the monitoring of the drive members by the controller maintaining the device side control and protection stage and the photovoltaic side protection stage galvanically isolated from each other.

25. The protection device according to claim 24, wherein the galvanic isolation is constituted by a transformer having a required level of isolation, to which is associated a control circuit operably associated with the controller.

26. The protection device according to claim 24, wherein the drive members are controlled by means of a digital line from the controller able to oscillate at a frequency compatible with the isolation transformer used, the driving topology being of half-bridge type with an appropriate connection circuit.

27. The protection device according to claim 24, wherein the drive members comprise a bipolar PNP transistor, a diode and a passive components network capable of controlling the opening time of the photovoltaic side protection circuit.

28. The protection device according to claim 21, wherein the device side control and protection stage comprises a power supply circuit for supplying the controller and the photovoltaic side protection stage, the power supply circuit comprising power input means for the connection of a power source of the device, the power output means for connection of a following device of the string to be supplied, power output interruption means for interrupting the power supply between the power input means and power output means.

29. The protection device according to claim 28, wherein the power output interruption means comprise at least one switch controlled by the controller.

30. The protection device according to claim 29, wherein the switch is constituted by a field-effect transistor.

31. The protection device according to claim 30, wherein the power output interruption means comprise a level sideshifter circuit that allows the driving of the switch by the controller with the power supply referred to the ground supply line of the power supply circuit.

32. The protection device according to claim 29, wherein the electric power supply circuit includes protection and interruption components comprising a switch adapted to short circuit the power input means.

33. The protection device according to claim 32, wherein the switch is formed by a field-effect transistor and by a resistor and is driven by the controller via a SCmos drive line.

34. The protection device according to claim 28, wherein the power supply circuit includes protection members interposed between the power input means and the controller adapted to protect the device against polarity reversals and to limit the current of the power transients, wherein, at the same time, not causing intervention of protections present in an eternal power circuit.

35. The protection device according to claim 21, further comprising voltage regulators, wherein the voltage regulators, the temperature measuring means and the voltage measurement means are suitable to manage the power supply of the controller providing devices suitable to convert and scale the voltages and currents present in the system in a range so as to mate reading possible by means of analog/digital converters, integrated in the logic of the controller and comprising conditioning/filtering means of the parameters so that they are limited to ranges predefined by the generators, making the protection device immune to external disturbances, both of the ducted and disbarred type.

36. A protection system for photovoltaic installations, comprising:
a plurality of photovoltaic generators with direct current;
wherein each generator is connected to a protection device;
wherein the protection devices are connected in series to form a string connected to at least an inverter;
wherein each of the devices are provided with protection components to interrupt the storage of energy by the photovoltaic generator associated through at least one switch;
wherein each of the devices is power supplied by an electricity grid by means of a power supply circuit;
wherein each of the devices are able to interrupt the power supply to the devices following it along the string.

37. The protection system for photovoltaic installations according to claim 36, wherein each device of the string processes data detected by temperature measuring means and by voltage measurement means and consequently controls the state of its photovoltaic side switch.

38. The protection system for photovoltaic installations according to claim 36, wherein each device of the string processes data detected by the temperature measuring means and by supply voltage measurement means and consequently controls the power supply to devices following it along the string.

39. The protection system for photovoltaic installations according to claim 36, wherein each of the protection devices is associated to a single generator.

40. The protection system for photovoltaic installations according to claim 36, wherein each protection device is associated to two generators and each generator is associated to a single protection device.
